(19) United States
(12) Patent Application Publication
(10) Pub. No.: US 2024/0214364 A1
(43) Pub. Date: Jun. 27, 2024

(54) MULTI-FACTOR AUTHENTICATION IN VIRTUAL REALITY ENVIRONMENTS

(71) Applicant: International Business Machines Corporation, Armonk, NY (US)

(72) Inventors: Humberto Orozco Cervantes, Tonalá (MX); Paul Llamas Virgen, Guadalajara (MX); Romelia H. Flores, Keller, TX (US)

(73) Assignee: International Business Machines Corporation, Armonk, NY (US)

(21) Appl. No.: 18/086,532

(22) Filed: Dec. 21, 2022

(51) Int. Cl. H04L 9/40

(52) U.S. Cl. CPC H04L 63/08; H04L 63/102; H04L 2463/082

(57) ABSTRACT

A method for authenticating a user to access a resource is disclosed. In one embodiment, such a method includes determining multiple devices on which to perform a multi-factor authentication sequence. The multiple devices include at least one virtual device and at least one physical device. As part of completing the multi-factor authentication sequence, the method requires a user to perform a first authentication action on a virtual device and a second authentication action on a physical device. In certain embodiments, the first authentication action and the second authentication action must be performed in a designated order and/or with a designated timing to successfully complete the multi-factor authentication sequence. In response to the user completing the multi-factor authorization sequence on both the virtual device and the physical device, the method grants authorization to the user to access a resource. A corresponding system and computer program product are also disclosed.

### BACKGROUND

### Field of the Invention

This invention relates to systems and methods for authenticating users in virtual reality environments.

### Background of the Invention

Virtual reality typically refers to a simulated 3D environment that enables a user to explore and interact with a virtual surrounding in a way that reflects a real-world environment. The environment is typically created with a combination of computer hardware and software. In most cases, standard virtual reality systems use either virtual reality headsets or multi-projected environments to generate realistic images, sounds, and other sensations that simulate a user's real world physical presence in the virtual environment and to facilitate interaction with the environment.

Forward-thinking companies may leverage virtual experiences to do much more than entertain. Virtual reality may be used to customize and test products, train users in different disciplines, and the like. However, virtual reality could benefit from additional development in areas such as security management. In real-world environments, multi-factor authentication (MFA) is used to protect and regulate access to sensitive data and other digital assets. However, this type of authentication has not as of yet been integrated into a virtual environment in any significant or meaningful way.

### SUMMARY

The invention has been developed in response to the present state of the art and, in particular, in response to the problems and needs in the art that have not yet been fully solved by currently available systems and methods. Accordingly, systems and methods have been developed to more effectively authenticate users in virtual reality environments. The features and advantages of the invention will become more fully apparent from the following description and appended claims, or may be learned by practice of the invention as set forth hereinafter.

Consistent with the foregoing, a method for authenticating a user to access a resource is disclosed. In one embodiment, such a method includes determining multiple devices on which to perform a multi-factor authentication sequence. The multiple devices include at least one virtual device and at least one physical device. As part of completing the multi-factor authentication sequence, the method requires a user to perform a first authentication action on a virtual device and a second authentication action on a physical device. In certain embodiments, the first authentication action and the second authentication action must be performed in a designated order and/or with a designated timing to successfully complete the multi-factor authentication sequence. In response to the user completing the multi-factor authorization sequence on both the virtual device and the physical device, the method grants authorization to the user to access a resource.

A corresponding system and computer program product are also disclosed and claimed herein.

### BRIEF DESCRIPTION OF THE DRAWINGS

In order that the advantages of the invention will be readily understood, a more particular description of the invention briefly described above will be rendered by reference to specific embodiments illustrated in the appended drawings. Understanding that these drawings depict only typical embodiments of the invention and are not therefore to be considered limiting of its scope, the embodiments of the invention will be described and explained with additional specificity and detail through use of the accompanying drawings, in which:

FIG. 1 is a high-level block diagram showing one example of a computing system for use in implementing embodiments of the invention;

FIG. 2 is a high-level block diagram showing a multi-factor authentication module and various internal sub-modules in accordance with the invention;

FIG. 3 is a process flow diagram showing one embodiment of a method for implementing multi-factor authentication in accordance with the invention;

FIGS. 4 through 6 show one example of a multi-factor authentication process in accordance with the invention utilizing a real-world physical device and a virtual device to authenticate a user; and

FIG. 7 is a process flow diagram showing another example of a multi-factor authentication process in accordance with the invention.

### DETAILED DESCRIPTION

It will be readily understood that the components of the present invention, as generally described and illustrated in the Figures herein, could be arranged and designed in a wide variety of different configurations. Thus, the following more detailed description of the embodiments of the invention, as represented in the Figures, is not intended to limit the scope of the invention, as claimed, but is merely representative of certain examples of presently contemplated embodiments in accordance with the invention. The presently described embodiments will be best understood by reference to the drawings, wherein like parts are designated by like numerals throughout.

Various aspects of the present disclosure are described by narrative text, flowcharts, block diagrams of computer systems and/or block diagrams of the machine logic included in computer program product (CPP) embodiments. With respect to any flowcharts, depending upon the technology involved, the operations can be performed in a different order than what is shown in a given flowchart. For example, again depending upon the technology involved, two operations shown in successive flowchart blocks may be performed in reverse order, as a single integrated step, concurrently, or in a manner at least partially overlapping in time.

A computer program product embodiment (“CPP embodiment” or “CPP”) is a term used in the present disclosure to describe any set of one, or more, storage media (also called “mediums”) collectively included in a set of one, or more, storage devices that collectively include machine readable code corresponding to instructions and/or data for performing computer operations specified in a given CPP claim. A “storage device” is any tangible device that can retain and store instructions for use by a computer processor. Without limitation, the computer readable storage medium may be an electronic storage medium, a magnetic storage medium, an optical storage medium, an electromagnetic storage medium, a semiconductor storage medium, a mechanical storage medium, or any suitable combination of the foregoing. Some known types of storage devices that include these mediums include: diskette, hard disk, random access memory (RAM), read-only memory (ROM), erasable programmable read-only memory (EPROM or Flash memory), static random access memory (SRAM), compact disc read-only memory (CD-ROM), digital versatile disk (DVD), memory stick, floppy disk, mechanically encoded device (such as punch cards or pits/lands formed in a major surface of a disc) or any suitable combination of the foregoing. A computer readable storage medium, as that term is used in the present disclosure, is not to be construed as storage in the form of transitory signals per se, such as radio waves or other freely propagating electromagnetic waves, electromagnetic waves propagating through a waveguide, light pulses passing through a fiber optic cable, electrical signals communicated through a wire, and/or other transmission media. As will be understood by those of skill in the art, data is typically moved at some occasional points in time during normal operations of a storage device, such as during access, de-fragmentation or garbage collection, but this does not render the storage device as transitory because the data is not transitory while it is stored.

Computing environment 100 contains an example of an environment for the execution of at least some of the computer code involved in performing the inventive methods, such as code 150 (i.e., a “multi-factor authentication module 150”) for authenticating a user to access a resource. In addition to block 150, computing environment 100 includes, for example, computer 101, wide area network (WAN) 102, end user device (EUD) 103, remote server 104, public cloud 105, and private cloud 106. In this embodiment, computer 101 includes processor set 110 (including processing circuitry 120 and cache 121), communication fabric 111, volatile memory 112, persistent storage 113 (including operating system 122 and block 150, as identified above), peripheral device set 114 (including user interface (UI) device set 123, storage 124, and Internet of Things (IOT) sensor set 125), and network module 115. Remote server 104 includes remote database 130. Public cloud 105 includes gateway 140, cloud orchestration module 141, host physical machine set 142, virtual machine set 143, and container set 144.

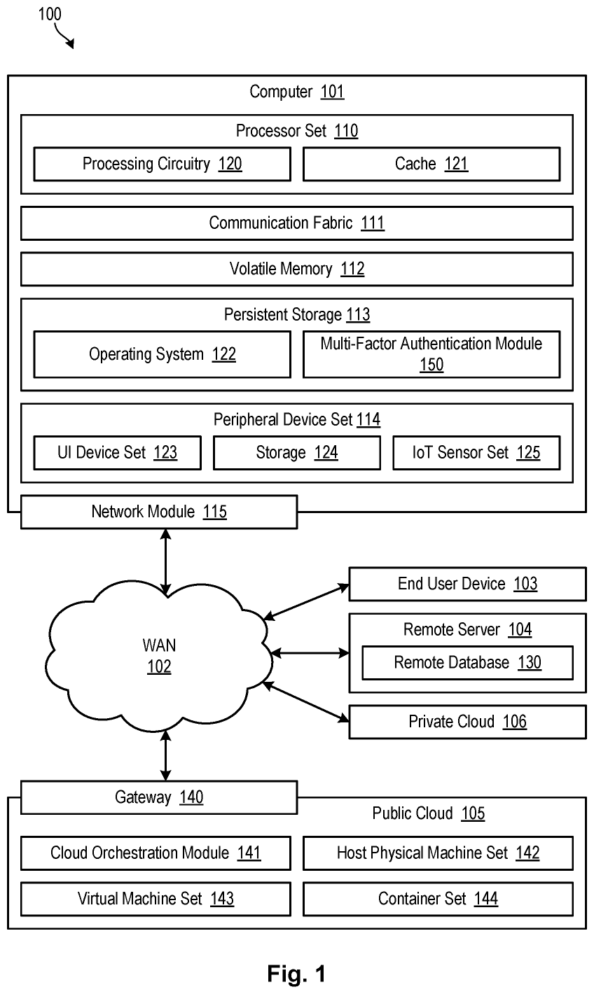

Computer 101 may take the form of a desktop computer, laptop computer, tablet computer, smart phone, smart watch or other wearable computer, mainframe computer, quantum computer or any other form of computer or mobile device now known or to be developed in the future that is capable of running a program, accessing a network or querying a database, such as remote database 130. As is well understood in the art of computer technology, and depending upon the technology, performance of a computer-implemented method may be distributed among multiple computers and/or between multiple locations. On the other hand, in this presentation of computing environment 100, detailed discussion is focused on a single computer, specifically computer 101, to keep the presentation as simple as possible. Computer 101 may be located in a cloud, even though it is not shown in a cloud in FIG. 1. On the other hand, computer 101 is not required to be in a cloud except to any extent as may be affirmatively indicated.

Processor set 110 includes one, or more, computer processors of any type now known or to be developed in the future. Processing circuitry 120 may be distributed over multiple packages, for example, multiple, coordinated integrated circuit chips. Processing circuitry 120 may implement multiple processor threads and/or multiple processor cores. Cache 121 is memory that is located in the processor chip package(s) and is typically used for data or code that should be available for rapid access by the threads or cores running on processor set 110. Cache memories are typically organized into multiple levels depending upon relative proximity to the processing circuitry. Alternatively, some, or all, of the cache for the processor set may be located “off chip.” In some computing environments, processor set 110 may be designed for working with qubits and performing quantum computing.

Computer readable program instructions are typically loaded onto computer 101 to cause a series of operational steps to be performed by processor set 110 of computer 101 and thereby effect a computer-implemented method, such that the instructions thus executed will instantiate the methods specified in flowcharts and/or narrative descriptions of computer-implemented methods included in this document (collectively referred to as “the inventive methods”). These computer readable program instructions are stored in various types of computer readable storage media, such as cache 121 and the other storage media discussed below. The program instructions, and associated data, are accessed by processor set 110 to control and direct performance of the inventive methods. In computing environment 100, at least some of the instructions for performing the inventive methods may be stored in block 150 in persistent storage 113.

Communication fabric 111 is the signal conduction path that allows the various components of computer 101 to communicate with each other. Typically, this fabric is made of switches and electrically conductive paths, such as the switches and electrically conductive paths that make up busses, bridges, physical input/output ports and the like. Other types of signal communication paths may be used, such as fiber optic communication paths and/or wireless communication paths.

Volatile memory 112 is any type of volatile memory now known or to be developed in the future. Examples include dynamic type random access memory (RAM) or static type RAM. Typically, volatile memory 112 is characterized by random access, but this is not required unless affirmatively indicated. In computer 101, the volatile memory 112 is located in a single package and is internal to computer 101, but, alternatively or additionally, the volatile memory may be distributed over multiple packages and/or located externally with respect to computer 101.

Persistent storage 113 is any form of non-volatile storage for computers that is now known or to be developed in the future. The non-volatility of this storage means that the stored data is maintained regardless of whether power is being supplied to computer 101 and/or directly to persistent storage 113. Persistent storage 113 may be a read only memory (ROM), but typically at least a portion of the persistent storage allows writing of data, deletion of data and re-writing of data. Some familiar forms of persistent storage include magnetic disks and solid state storage devices. Operating system 122 may take several forms, such as various known proprietary operating systems or open source Portable Operating System Interface-type operating systems that employ a kernel. The code included in block 150 typically includes at least some of the computer code involved in performing the inventive methods.

Peripheral device set 114 includes the set of peripheral devices of computer 101. Data communication connections between the peripheral devices and the other components of computer 101 may be implemented in various ways, such as Bluetooth connections, Near-Field Communication (NFC) connections, connections made by cables (such as universal serial bus (USB) type cables), insertion-type connections (for example, secure digital (SD) card), connections made through local area communication networks and even connections made through wide area networks such as the internet. In various embodiments, UI device set 123 may include components such as a display screen, speaker, microphone, wearable devices (such as goggles and smart watches), keyboard, mouse, printer, touchpad, game controllers, and haptic devices. Storage 124 is external storage, such as an external hard drive, or insertable storage, such as an SD card. Storage 124 may be persistent and/or volatile. In some embodiments, storage 124 may take the form of a quantum computing storage device for storing data in the form of qubits. In embodiments where computer 101 is required to have a large amount of storage (for example, where computer 101 locally stores and manages a large database) then this storage may be provided by peripheral storage devices designed for storing very large amounts of data, such as a storage area network (SAN) that is shared by multiple, geographically distributed computers. IoT sensor set 125 is made up of sensors that can be used in Internet of Things applications. For example, one sensor may be a thermometer and another sensor may be a motion detector.

Network module 115 is the collection of computer software, hardware, and firmware that allows computer 101 to communicate with other computers through WAN 102. Network module 115 may include hardware, such as modems or Wi-Fi signal transceivers, software for packetizing and/or de-packetizing data for communication network transmission, and/or web browser software for communicating data over the internet. In some embodiments, network control functions and network forwarding functions of network module 115 are performed on the same physical hardware device. In other embodiments (for example, embodiments that utilize software-defined networking (SDN)), the control functions and the forwarding functions of network module 115 are performed on physically separate devices, such that the control functions manage several different network hardware devices. Computer readable program instructions for performing the inventive methods can typically be downloaded to computer 101 from an external computer or external storage device through a network adapter card or network interface included in network module 115.

WAN 102 is any wide area network (for example, the internet) capable of communicating computer data over non-local distances by any technology for communicating computer data, now known or to be developed in the future. In some embodiments, the WAN 102 may be replaced and/or supplemented by local area networks (LANs) designed to communicate data between devices located in a local area, such as a Wi-Fi network. The WAN and/or LANs typically include computer hardware such as copper transmission cables, optical transmission fibers, wireless transmission, routers, firewalls, switches, gateway computers and edge servers.

End user device (EUD) 103 is any computer system that is used and controlled by an end user (for example, a customer of an enterprise that operates computer 101), and may take any of the forms discussed above in connection with computer 101. EUD 103 typically receives helpful and useful data from the operations of computer 101. For example, in a hypothetical case where computer 101 is designed to provide a recommendation to an end user, this recommendation would typically be communicated from network module 115 of computer 101 through WAN 102 to EUD 103. In this way, EUD 103 can display, or otherwise present, the recommendation to an end user. In some embodiments, EUD 103 may be a client device, such as thin client, heavy client, mainframe computer, desktop computer and so on.

Remote server 104 is any computer system that serves at least some data and/or functionality to computer 101. Remote server 104 may be controlled and used by the same entity that operates computer 101. Remote server 104 represents the machine(s) that collect and store helpful and useful data for use by other computers, such as computer 101. For example, in a hypothetical case where computer 101 is designed and programmed to provide a recommendation based on historical data, then this historical data may be provided to computer 101 from remote database 130 of remote server 104.

Public cloud 105 is any computer system available for use by multiple entities that provides on-demand availability of computer system resources and/or other computer capabilities, especially data storage (cloud storage) and computing power, without direct active management by the user. Cloud computing typically leverages sharing of resources to achieve coherence and economies of scale. The direct and active management of the computing resources of public cloud 105 is performed by the computer hardware and/or software of cloud orchestration module 141. The computing resources provided by public cloud 105 are typically implemented by virtual computing environments that run on various computers making up the computers of host physical machine set 142, which is the universe of physical computers in and/or available to public cloud 105. The virtual computing environments (VCEs) typically take the form of virtual machines from virtual machine set 143 and/or containers from container set 144. It is understood that these VCEs may be stored as images and may be transferred among and between the various physical machine hosts, either as images or after instantiation of the VCE. Cloud orchestration module 141 manages the transfer and storage of images, deploys new instantiations of VCEs and manages active instantiations of VCE deployments. Gateway 140 is the collection of computer software, hardware, and firmware that allows public cloud 105 to communicate through WAN 102.

Some further explanation of virtualized computing environments (VCEs) will now be provided. VCEs can be stored as “images.” A new active instance of the VCE can be instantiated from the image. Two familiar types of VCEs are virtual machines and containers. A container is a VCE that uses operating-system-level virtualization. This refers to an operating system feature in which the kernel allows the existence of multiple isolated user-space instances, called containers. These isolated user-space instances typically behave as real computers from the point of view of programs running in them. A computer program running on an ordinary operating system can utilize all resources of that computer, such as connected devices, files and folders, network shares, CPU power, and quantifiable hardware capabilities. However, programs running inside a container can only use the contents of the container and devices assigned to the container, a feature which is known as containerization.

Private cloud 106 is similar to public cloud 105, except that the computing resources are only available for use by a single enterprise. While private cloud 106 is depicted as being in communication with WAN 102, in other embodiments a private cloud may be disconnected from the internet entirely and only accessible through a local/private network. A hybrid cloud is a composition of multiple clouds of different types (for example, private, community or public cloud types), often respectively implemented by different vendors. Each of the multiple clouds remains a separate and discrete entity, but the larger hybrid cloud architecture is bound together by standardized or proprietary technology that enables orchestration, management, and/or data/application portability between the multiple constituent clouds. In this embodiment, public cloud 105 and private cloud 106 are both part of a larger hybrid cloud.

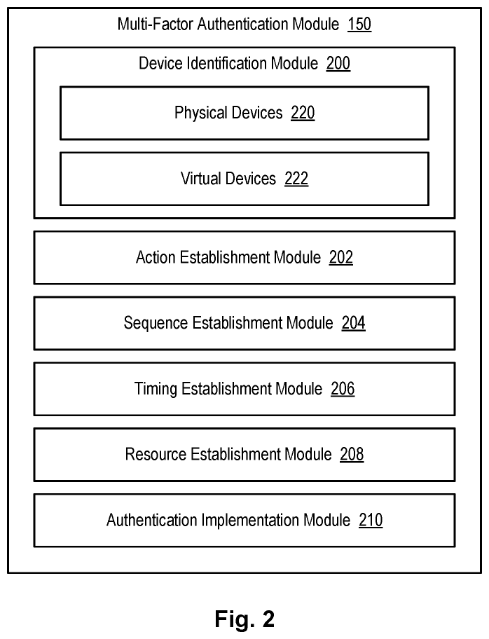

FIG. 2 is a high-level block diagram showing a multi-factor authentication module 150 and various internal sub-modules in accordance with the invention. The multi-factor authentication module 150 may be utilized to authenticate a user before unlocking or accessing a resource, and may incorporate a virtual reality environment and virtual devices within the virtual reality environment into this process. The multi-factor authentication module 150 may be used to expand virtual reality to include more sophisticated security management to enhance security control and management of resources within a virtual reality environment.

The multi-factor authentication module 150 as well as the illustrated sub-modules contained therein may be implemented in hardware, software, firmware, or combinations thereof. These modules are presented by way of example and not limitation. More or fewer modules may be provided in different embodiments. For example, the functionality of some modules may be combined into a single or smaller number of modules, or the functionality of a single module may be distributed across several modules.

As shown, in one embodiment, a multi-factor authentication module 150 in accordance with the invention may include one or more of a device identification module 200, action establishment module 202, sequence establishment module 204, timing establishment module 206, resource establishment module 208, and authentication implementation module 210.

The device identification module 200 may be configured to identify devices to be utilized by the multi-factor authentication module 150 when authenticating a user. These devices may include both physical devices 220 (e.g., physical computers, smart phones, tablets, physical kiosks, etc.) that are used in real-world environments, and virtual devices 222 (e.g., virtual computers, virtual smart phones, virtual tablets, virtual kiosks etc.) that may be implemented in virtual reality environments. As will be described in more detail hereafter, the physical devices 220 and virtual devices 222 may be utilized to perform authentication actions that are associated with a multi-factor authentication sequence. In general the multi-factor authentication sequence may be made up of a series of authentication actions that a user may perform into order to be authenticated and thereby gain access to a resource (e.g., a device, a product, an account, a capability, a feature, a service, a database, a website, a privilege, etc.). The multi-factor authentication sequence may be created by end users to secure their own resources within a virtual reality environment, or by a third party to secure virtual reality resources until a user successfully completes the multi-factor authentication sequence to thereby unlock and gain access to the resources.

The action establishment module 202 may be used to establish authentication actions to be performed as part of a multi-factor authentication sequence. These authentication actions may include actions to be performed on the physical devices 220 as well as actions to be performed on the virtual devices 222. The sequence establishment module 204 may establish a sequence or order for the authentication actions to be performed in order to successfully complete the multi-factor authentication sequence. Similarly, the timing establishment module 206 may establish the timing in which the authentication actions need to be performed to successfully complete the multi-factor authentication sequence. For example, certain authentication actions may need to be completed in a designated amount of time or the authentication actions need to be performed with a designated temporal proximity in order to be completed successfully as part of the multi-factor authentication sequence. In certain embodiments, the order and timing of actions may be an order or time that actions need to occur in a real-world environment and a virtual reality environment for the multi-factor authentication sequence to be completed successfully.

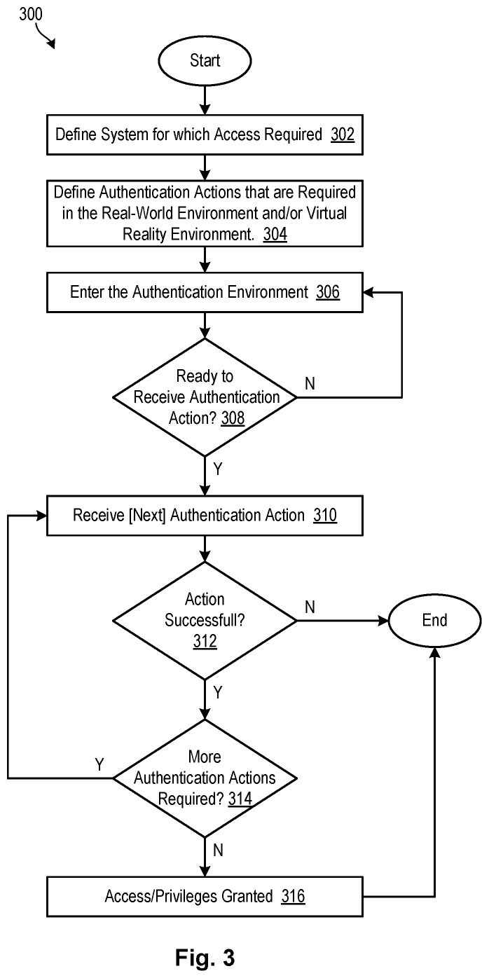

The resource establishment module 208 may establish the resources that are unlocked by successful completion of the multi-factor authentication sequence. As indicated above, a resource may include a device, a product, an account, a capability, a feature, a service, a database, a website, a privilege, and/or the like. The authentication implementation module 210 may be used to implement the multi-factor authentication sequence established by the multi-factor authentication module 150. In other words, the authentication implementation module 210 may take a user step-by-step through the multi-factor authentication sequence to determine if a user is authentic and, if so, provide access to the resource. In certain embodiments, the authentication implementation module 210 may execute all or part of a method such as that illustrated and described in FIG. 3.

Referring to FIG. 3, one embodiment of a method 300 for implementing multi-factor authentication in accordance with the invention is illustrated. This method 300 is provided by way of example and not limitation. As shown, the method 300 initially defines 302 the system for which access is regulated. This step 302 may include determining the resource or resources for which the multi-factor authentication sequence is designed to control access. The method 300 then defines 304 the authentication actions that are required to complete the multi-factor authentication sequence. This may include determining which authentication actions are required in a real-world environment and which authentication actions are required in a virtual reality environment and their timing and sequence. A user may then enter 306 the authentication environment, which may be one of the real-world environment and the virtual reality environment in which a first authentication action of the multi-factor authentication sequence is performed.

The method 300 then determines 308 whether an authentication action is ready to be received—i.e., whether a user has been prompted to perform a first authentication action of the multi-factor authentication sequence (e.g., enter a password, enter a code, provide a biometric indicator, enter a CAPTCHA code, solve a puzzle, etc.). If so, the method 300 receives 310 the authentication action from the user. The method 300 then determines 312 whether the authentication action was completed successfully. In certain embodiments, the user may be given a certain number of attempts to successfully complete the authentication action. If the user is not successful, the method 300 ends.

If the user is successful, the method 300 proceeds to step 314 and determines 314 whether more authentication actions are required to complete the multi-factor authentication sequence. If so, the method 300 receives 310 the next authentication action in the multi-factor authentication sequence and determines 312 whether the authentication action was completed successfully. This process may repeat until all authentication actions associated with the multi-factor authentication sequence are successfully completed. If any of the authentication actions are not completed successfully, the method 300 ends without granting access to the resource. If all of the authentication actions are completed successfully, the method 300 grants 316 access to the resource.

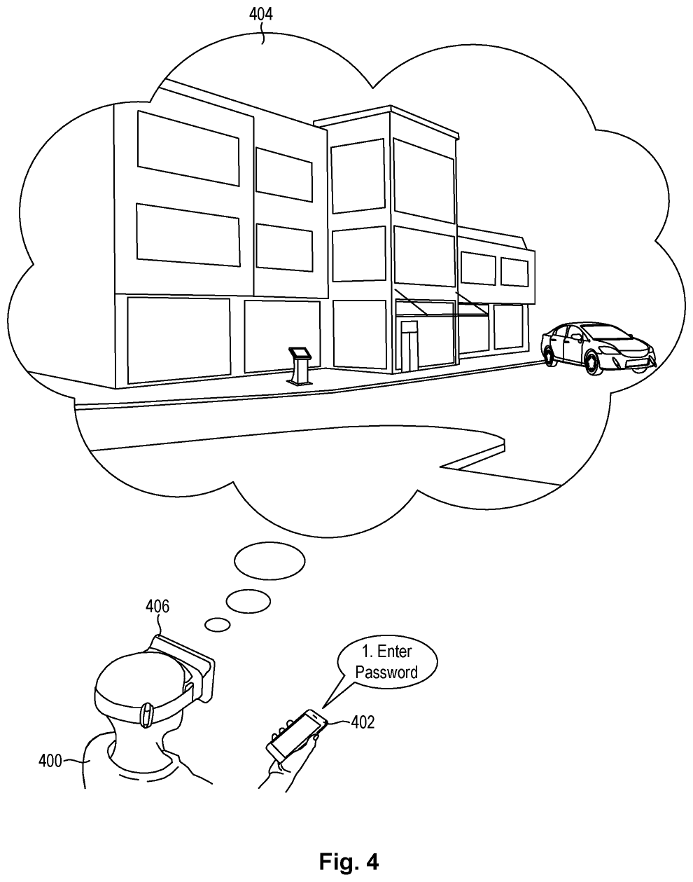

Referring to FIGS. 4 through 6, one example of a multi-factor authentication process in accordance with the invention is illustrated showing use of a real-world physical device and a virtual device to authenticate a user. As shown in FIG. 4, in this example, in order to authenticate a user 400, the user 400 may be prompted to perform an authentication action on the user's physical device 220, such as a smart phone 402. For example, the user 400 may be required to enter a password or biometric identifier on the user's physical device 220 as part of a multi-factor authentication sequence. Once this authentication action is completed successfully, the user 400 may be prompted to perform a second authentication action. In certain embodiments, this second authentication action may be an action performed in a virtual reality environment 404 such as that shown in FIG. 4. In certain embodiments, the user 400 is able to access the virtual reality environment 404 using a virtual reality device 406 such as the illustrated virtual reality headset 406.

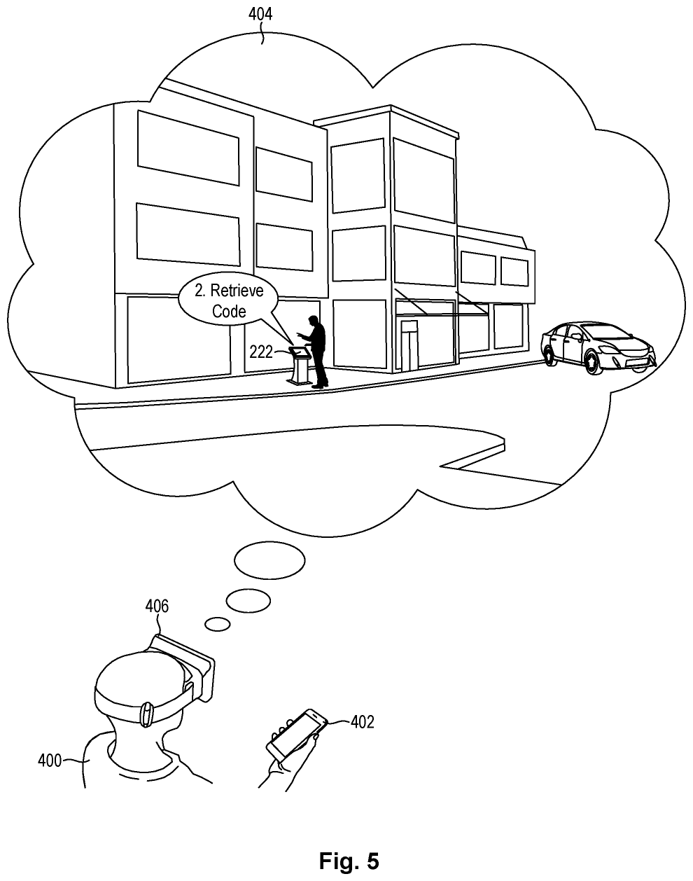

As shown in FIG. 5, in certain embodiments, in order to complete the multi-factor authentication sequence, the user 400 may be required to perform an authentication action in the virtual reality environment 404. For example, the user 400 may be required to navigate to and retrieve a code from a virtual device 222 such as a virtual kiosk 222. To accomplish this, the user 400 may, in certain embodiments, initially travel to the virtual kiosk 222 in the virtual reality environment 404. The user 400 may then retrieve the code from the virtual kiosk 222. In certain cases, the user may be required to enter a password into the virtual kiosk 222 to receive the code. In certain embodiments, the user 400 may experience the virtual reality environment 404 in first person view or potentially third person view when retrieving the code from the virtual device 222.

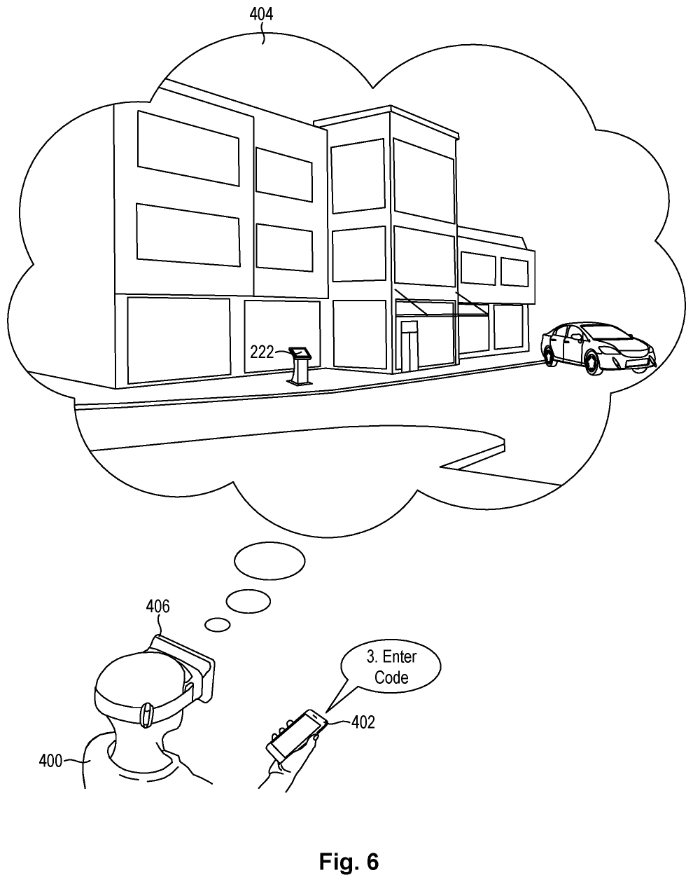

Once the code is retrieved in the virtual reality environment 404, the user 400 may then be required to enter the code into the user's physical device 220, as shown in FIG. 6. Once the code is entered into the physical device 220, the multi-factor authentication sequence may be complete and the user 400 may be granted access to the resource that is associated therewith. In the illustrated embodiment, the multi-factor authentication sequence is “nested” in that the user transitions from the physical device 220 to the virtual device 222 and then back to the physical device 220 to enter a code retrieved from the virtual device 222. This represents just one way of implementing a multi-factor authentication sequence and is not intended to be limiting.

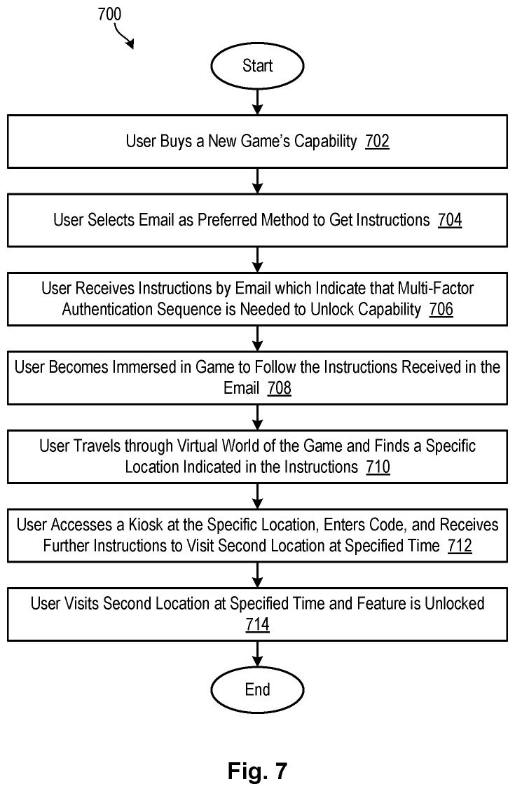

Referring to FIG. 7, a process flow diagram showing another example or use case of a multi-factor authentication process in accordance with the invention is illustrated. In this use case, a user buys 702 a new capability for a game, such as a video game or a virtual reality game. This purchase may be performed in a real or virtual environment. As part of the purchase, the user selects 704 a desired method of communication to get instructions for unlocking the new game capability. In this example, the user elects to receive 706 the instructions by email on the user's physical device 220, such as a physical computer or smart phone. These instructions may indicate 706 that a multi-factor authentication sequence is needed to unlock the new game capability and that various authentication actions associated with this multi-factor authentication sequence must be performed from within the game in order to unlock the game capability. In order to comply with the instructions, the user may then become immersed 708 in the game (using, for example, a virtual reality device such as a virtual reality headset) to follow the instructions received in the email.

In one scenario, the user may then travel 710 through the virtual world of the game and find 710 a specific location in the game as indicated in the instructions. The user may then access 712 a virtual kiosk as the specific location, enter 712 a code as set forth in the instruction, and receive 712 further instructions to visit a second location in the virtual world at a specified time. The user may then visit 714 the second location at the specified time to unlock the new game capability. Thus, in this example, a multi-factor authentication sequence includes authentication actions both in a real-world environment and a virtual reality environment in order to unlock a resource, in this example a new game capability. Other variations of this use case are possible and within the scope of the invention.

The flowcharts and block diagrams in the Figures illustrate the architecture, functionality, and operation of possible implementations of systems, methods, and computer program products according to various embodiments of the present invention. In this regard, each block in the flowcharts or block diagrams may represent a module, segment, or portion of code, which comprises one or more executable instructions for implementing the specified logical function(s). It should also be noted that, in some alternative implementations, the functions noted in the block may occur out of the order noted in the Figures. For example, two blocks shown in succession may, in fact, be executed substantially concurrently, or the blocks may sometimes be executed in the reverse order, depending upon the functionality involved. Other implementations may not require all of the disclosed steps to achieve the desired functionality. It will also be noted that each block of the block diagrams and/or flowchart illustrations, and combinations of blocks in the block diagrams and/or flowchart illustrations, may be implemented by special purpose hardware-based systems that perform the specified functions or acts, or combinations of special purpose hardware and computer instructions.

1. A method for authenticating a user to access a resource, the method comprising:
determining a plurality of devices on which to perform a multi-factor authentication sequence, wherein the plurality of devices comprises a virtual device and a physical device;
as part of completing the multi-factor authentication sequence, requiring a user to perform a first authentication action on the virtual device and a second authentication action on the physical device; and
in response to the user completing the multi-factor authorization sequence on both the virtual device and the physical device, granting authorization to the user to access a resource.

2. The method of claim 1, wherein the multi-factor authentication sequence has associated therewith an order for performing the first authentication action and the second authentication action.

3. The method of claim 1, wherein the multi-factor authentication sequence has associated therewith a timing for performing the first authentication action and the second authentication action.

4. The method of claim 1, wherein performing the first authentication action comprises requiring a user to navigate to a designated location within a virtual reality environment in order to perform the first authentication action.

5. The method of claim 1, wherein the multi-factor authentication sequence is a two-factor authentication sequence.

6. The method of claim 1, wherein the first authentication action can only be performed after completing the second authentication action.

7. The method of claim 1, wherein the second authentication action can only be performed after completing the first authentication action.

8. A computer program product for authenticating a user to access a resource, the computer program product comprising a computer-readable storage medium having computer-usable program code embodied therein, the computer-usable program code configured to perform the following when executed by at least one processor:
determine a plurality of devices on which to perform a multi-factor authentication sequence, wherein the plurality of devices comprises a virtual device and a physical device;
as part of completing the multi-factor authentication sequence, require a user to perform a first authentication action on the virtual device and a second authentication action on the physical device; and
in response to the user completing the multi-factor authorization sequence on both the virtual device and the physical device, grant authorization to the user to access a resource.

9. The computer program product of claim 8, wherein the multi-factor authentication sequence has associated therewith an order for performing the first authentication action and the second authentication action.

10. The computer program product of claim 8, wherein the multi-factor authentication sequence has associated therewith a timing for performing the first authentication action and the second authentication action.

11. The computer program product of claim 8, wherein performing the first authentication action comprises requiring a user to navigate to a designated location within a virtual reality environment in order to perform the first authentication action.

12. The computer program product of claim 8, wherein the multi-factor authentication sequence is a two-factor authentication sequence.

13. The computer program product of claim 8, wherein the first authentication action can only be performed after completing the second authentication action.

14. The computer program product of claim 8, wherein the second authentication action can only be performed after completing the first authentication action.

15. A system for authenticating a user to access a resource, the system comprising:
at least one processor;
at least one memory device operably coupled to the at least one processor and storing instructions for execution on the at least one processor, the instructions causing the at least one processor to:
determine a plurality of devices on which to perform a multi-factor authentication sequence, wherein the plurality of devices comprises a virtual device and a physical device;
as part of completing the multi-factor authentication sequence, require a user to perform a first authentication action on the virtual device and a second authentication action on the physical device; and
in response to the user completing the multi-factor authorization sequence on both the virtual device and the physical device, grant authorization to the user to access a resource.

16. The system of claim 15, wherein the multi-factor authentication sequence has associated therewith an order for performing the first authentication action and the second authentication action.

17. The system of claim 15, wherein the multi-factor authentication sequence has associated therewith a timing for performing the first authentication action and the second authentication action.

18. The system of claim 15, wherein performing the first authentication action comprises requiring a user to navigate to a designated location within a virtual reality environment in order to perform the first authentication action.

19. The system of claim 15, wherein the multi-factor authentication sequence is a two-factor authentication sequence.

20. The system of claim 15, wherein one of the first authentication action and the second authentication action can only be performed after completing the other of the first authentication action and the second authentication action.
